(19) United States
(12) Patent Application Publication
(10) Pub. No.: US 2026/0134769 A1
(43) Pub. Date: May 14, 2026

(54) NOTIFICATION APPARATUS, SYSTEM, METHOD, AND COMPUTER-READABLE MEDIUM

(71) Applicant: NEC Corporation, Minato-ku, Tokyo (JP)

(72) Inventors: Koki SAKAI, Tokyo (JP); Yoko Tanaka, Tokyo (JP); Nozomi MATSUMOTO, Tokyo (JP)

(73) Assignee: NEC Corporation, Minato-ku, Tokyo (JP)

(21) Appl. No.: 19/119,518

(22) PCT Filed: Oct. 18, 2022
(86) PCT No.: PCT/JP2022/038684

§ 371 Date: Apr. 9, 2025

(51) Int. Cl. G08B 25/00; G06V 20/52

(52) U.S. Cl. CPC G08B 25/006; G06V 20/52

(57) ABSTRACT

Event detection means detects that a predetermined event has occurred. Positional information detection means detects positional information of a subject who is a position detection target person. Specification means specifies a notification target subject based on positional information of a place where occurrence of a predetermined event is detected and positional information detected by the positional information detection means. Notification means notifies a terminal of the notification recipient registered in association with the subject specified by the specification means of the positional information of the subject.

### TECHNICAL FIELD

The present disclosure relates to a notification apparatus, a system, a method, and a computer-readable medium.

### BACKGROUND ART

As the related art, Patent Literature 1 discloses a security system. In Patent Literature 1, an elderly person, a child, or the like is assumed as a subject who is a position detection target person. The subject carries a radio tag into which a security buzzer is integrated. The radio tag stores an identifier (ID) for personal identification. A security surveillance camera installed on a utility pole or the like receives an ID from the radio tag carried by a subject. In a case where the ID is received, the security surveillance camera transmits position detection information including the received ID to a server. The server accumulates position detection information transmitted from the security surveillance camera to construct a database. The server transmits the position detection information to a terminal of a caretaker who is a person who takes care of the subject.

In a case where the ID is received from the radio tag carried by the subject, the security surveillance camera determines whether a sound input from a microphone is a sound with a predetermined value or more. In a case where the sound input from the microphone is a sound with the predetermined value or more, the security surveillance camera determines that the security buzzer is operating. In that case, the security surveillance camera adds danger information indicating that the subject is likely to be involved in a certain crime or accident to the position detection information transmitted to the server. In a case where the position detection information to which the danger information is added is received, the server transmits the position detection information and the danger information to the terminal of the caretaker.

### CITATION LIST

### Patent Literature

Patent Literature 1: Japanese Unexamined Patent Application Publication No. 2017-76201

### SUMMARY OF INVENTION

### Technical Problem

In Patent Literature 1, in a case where the security buzzer is sounded, the security surveillance camera transmits danger information to a terminal of the caretaker in addition to position detection information of the subject. In this case, the caretaker can be made aware that the subject is ringing the security buzzer, that is, the subject may be involved in a certain crime or accident. However, in Patent Literature 1, the danger information is transmitted only when the subject actively rings the security buzzer. Therefore, in Patent Literature 1, when a dangerous event that the subject does not notice occurs around the subject, danger information is not transmitted to the caretaker.

In view of the above circumstances, an object of the present disclosure is to provide a notification apparatus, a system, a method, and a computer-readable medium capable of notifying a notification recipient that a subject is at a place related to a place where a certain event has occurred even if the subject is not aware of the occurrence of the certain event.

### Solution to Problem

In order to achieve the above object, according to a first aspect of the present disclosure, a notification apparatus is provided. The notification apparatus includes: event detection means for detecting that a predetermined event has occurred; positional information detection means for detecting positional information of a subject who is a position detection target person; specification means for specifying a notification target subject based on positional information of a place where occurrence of the predetermined event is detected and the detected positional information; and notification means for notifying a terminal of a notification recipient registered in association with the subject specified by the specification means of positional information of the subject.

According to a second aspect of the present disclosure, a notification system is provided. The notification system includes: event detection means for detecting that a predetermined event has occurred; positional information detection means for detecting positional information of a subject who is a position detection target person; specification means for specifying a notification target subject based on positional information of a place where occurrence of the predetermined event is detected and the detected positional information; and notification means for notifying a terminal of a notification recipient registered in association with the subject specified by the specification means of positional information of the subject.

According to a third aspect of the present disclosure, a notification method is provided. The notification method includes: detecting that a predetermined event has occurred; detecting positional information of a subject who is a position detection target person; specifying a notification target subject based on positional information of a place where occurrence of the predetermined event is detected and the detected positional information; and notifying a terminal of a notification recipient registered in association with the specified subject of positional information of the subject.

According to a fourth aspect of the present disclosure, a computer-readable medium is provided. The computer-readable medium storing a program that causes a processor to execute a process including: detecting that a predetermined event has occurred; detecting positional information of a subject who is a position detection target person; specifying a notification target subject based on positional information of a place where occurrence of the predetermined event is detected and the detected positional information; and notifying a terminal of a notification recipient registered in association with the specified subject of positional information of the subject.

### Advantageous Effects of Invention

The notification apparatus, the system, the method, and the computer-readable medium according to the present disclosure can notify a notification recipient that a subject is at a place related to a place where a certain event has occurred even if the subject is not aware that the certain event has occurred.

### BRIEF DESCRIPTION OF DRAWINGS

FIG. 1 is a block diagram illustrating an overall configuration example of a notification apparatus according to the present disclosure.

FIG. 2 is a block diagram illustrating a notification system according to a first example embodiment of the present disclosure.

FIG. 3 is a flowchart illustrating an operation procedure of the notification apparatus.

FIG. 4 is a block diagram illustrating a notification system according to a second example embodiment of the present disclosure.

FIG. 5 is a block diagram illustrating a configuration example of a notification apparatus according to a modified example.

FIG. 6 is a block diagram illustrating a configuration example of a computer device.

### EXAMPLE EMBODIMENT

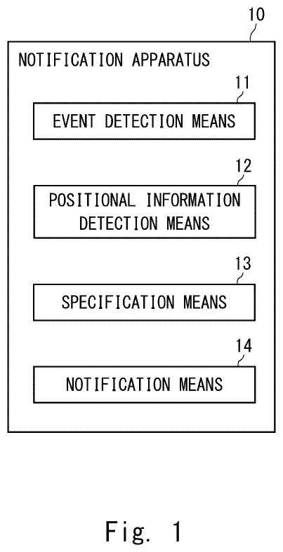

Before example embodiments of the present disclosure are described, an overview of the present disclosure will be described. FIG. 1 illustrates an overall configuration example of a notification apparatus according to the present disclosure. A notification apparatus 10 includes event detection means 11, positional information detection means 12, specification means 13, and

The event detection means 11 detects that a predetermined event has occurred. The positional information detection means 12 detects positional information of a subject who is a position detection target person. The specification means 13 specifies a notification target subject based on the positional information of a place where the occurrence of the predetermined event is detected and the positional information of the subject detected by the positional information detection means 12. The notification means 14 notifies a terminal of the notification recipient registered in association with the specified subject of the positional information of the subject.

In the present disclosure, the event detection means 11 detects occurrence of the predetermined event, and the specification means 13 specifies a notification target person based on a place where the occurrence of the predetermined event has been detected and positional information of the target person. In the present disclosure, in a case where the occurrence of the predetermined event is detected by the event detection means 11, the terminal of the notification recipient registered in association with the specified subject is notified of the positional information of the subject. Therefore, according to the present disclosure, the notification recipient can be notified that the subject is at a place related to a place where a certain event has occurred even if the subject is not aware of the occurrence of the certain event.

Hereinafter, example embodiments according to the present disclosure will be described in detail with reference to the drawings. The following description and drawings will be omitted or simplified as appropriate to clarify description. The same elements and similar elements are denoted by the same reference symbols in the following drawings, and repeated description will be omitted as necessary.

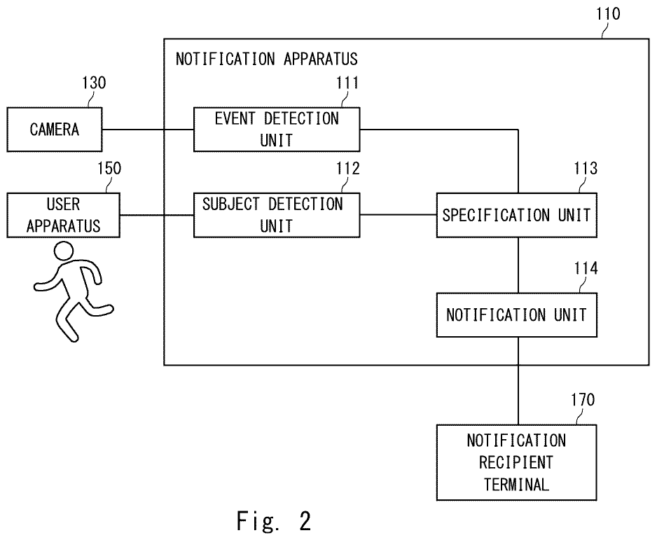

FIG. 2 illustrates a notification system according to a first example embodiment of the present disclosure. The notification system 100 includes a notification apparatus 110, a camera 130, a user apparatus 150, and a notification recipient terminal 170. In the present example embodiment, the notification apparatus 110 detects that a predetermined event has occurred in a place such as an intersection. The notification apparatus 110 detects a position of a user as a position detection target. In a case where the user is in a place related to the place where the predetermined event has occurred, the notification apparatus 110 notifies the notification recipient terminal 170 used by another user related to the user that the user is in a place related to the place where the predetermined event has occurred.

The camera 130 outputs a camera image. The camera 130 images, for example, a place such as a road where a person or a vehicle travels near an intersection. The camera 130 is installed, for example, at a traffic light, a street light, or the like. The camera 130 may be a surveillance camera installed at a parking lot or an entrance of a store or the like. Only one camera 130 is illustrated in FIG. 2, but the number of cameras 130 is not particularly limited to 1. For example, a plurality of cameras 130 may be disposed at one intersection.

The user apparatus 150 is an apparatus carried by a notification target user, that is, a subject. The subject is, for example, a user who is watched in a watching service. The subject includes, for example, a child and an elderly person. The user apparatus 150 transmits predetermined information to the notification apparatus 110. The predetermined information includes identification information of the user. For example, a radio tag is used for the user apparatus 150. The user apparatus 150 stores identification information of the user, that is, the subject. The user apparatus 150 transmits the identification information to the notification apparatus 110 using, for example, short-range wireless communication such as Bluetooth (registered trademark).

The user apparatus 150 is not limited to the radio tag and may be a radio communication device such as a smartphone carried by the user. For example, an application that transmits identification information to the notification apparatus 110 is installed in a smartphone carried by the user. The application transmits the identification information to the notification apparatus 110 periodically or at a timing at which communication with the notification apparatus 110 can be executed.

The notification apparatus 110 includes an event detection unit 111, a subject detection unit 112, a specification unit 113, and a notification unit 114. The notification apparatus 110 includes, for example, one or more memories and one or more processors. At least some of functions of the units in the notification apparatus 110 can be implemented by the processor operating according to a program read from the memory. The notification apparatus 110 corresponds to the notification apparatus 10 illustrated in FIG. 1.

The event detection unit 111 acquires a camera image from the camera 130. The event detection unit 111 detects occurrence of a predetermined event in a place where the camera 130 is installed, for example, based on the camera image. For example, the event detection unit 111 detects an event that may harm the subject as the predetermined event. Specifically, the event detection unit 111 may detect a traffic accident, a fire, a suspicious person, or the like as the predetermined event. The event detection unit 111 may detect a dangerous event leading to a traffic accident, for example, a vehicle that travels at a high speed or runs away. The event detection unit 111 may detect appearance of an animal that is likely to harm a person such as a bear as the predetermined event. For example, the event detection unit 111 may input a camera image to a trained artificial intelligence (AI) engine to detect occurrence of the predetermined event. The event detection unit 111 corresponds to the event detection means 11 illustrated in FIG. 1.

The subject detection unit 112 detects a user who is a subject and acquires positional information of the user. For example, an antenna receiving information transmitted from the user apparatus 150 is installed at an intersection where the camera 130 is installed. In a case where the identification information transmitted from the radio tag is received at the intersection where the notification apparatus 110 is installed, the subject detection unit 112 detects presence of the subject at the intersection. The subject detection unit 112 acquires the positional information of the intersection as positional information of the place where the subject is detected. The subject detection unit 112 may estimate a distance from the intersection to the user apparatus 150 based on a radio wave intensity of the information transmitted from the user apparatus 150.

Alternatively, the subject detection unit 112 may receive positional information measured using a global navigation satellite system (GNSS) or the like from the user apparatus 150. The subject detection unit 112 may accumulate the acquired positional information in a storage device (not illustrated) for each detected subject. The subject detection unit 112 corresponds to the positional information detection means 12 illustrated in FIG. 1.

In a case where the event detection unit 111 detects occurrence of the predetermined event, the specification unit 113 specifies a notification target subject based on positional information of a place where the occurrence of the predetermined event is detected and positional information of the subject detected by the subject detection unit 112. For example, the specification unit 113 specifies a subject in a place related to the place where the predetermined event has occurred as a notification target subject. For example, the specification unit 113 may specify a subject who is within a predetermined distance from a place where the occurrence of the predetermined event is detected as the notification target subject.

In a case where the occurrence of the predetermined event is detected at the intersection where the camera 130 is installed, the specification unit 113 specifies a subject who is near the intersection as a notification target subject. For example, in a case where the subject detection unit 112 receives identification information from a plurality of subjects at the intersection where the camera 130 is installed, the specification unit 113 may specify the plurality of subjects as subjects who are near the intersection. For example, the specification unit 113 may specify the subject detected by the subject detection unit 112 as the subject who is near the intersection in a time from a time slightly before the time at which the occurrence of the predetermined event is detected to a time slightly after that time.

The specification unit 113 may estimate a movement destination of the subject based on a history of the positional information of subjects detected by the subject detection unit 112. In this case, the specification unit 113 may specify a subject who is estimated to move to a place where occurrence of the predetermined event is detected as a notification target subject. The specification unit 113 corresponds to the specification means 13 illustrated in FIG. 1.

The notification unit 114 notifies the positional information of the subject to the notification recipient terminal 170 registered in association with the subject specified by the specification unit 113. The notification recipient terminal 170 may be, for example, a device such as a smartphone, a tablet, a personal computer, or a dedicated terminal that has a communication function. The notification unit 114 transmits positional information of the subject to the notification recipient terminal 170 using, for example, communication tools such as an e-mail, a short message, or a telephone. The notification unit 114 may notify the notification recipient terminal 170 of a type of a generated predetermined event in addition to the positional information.

For example, the notification unit 114 has a table in which a notification recipient related to the subject and the notification recipient terminal 170 used by the notification recipient are stored for each subject. In the table, a plurality of notification recipients and a plurality of notification recipient terminals 170 can be stored for one subject. The notification unit 114 specifies the notification recipient terminal 170 related to the specified subject with reference to the table, and notifies the specified notification recipient terminal 170 of the positional information of the subject. The notification unit 114 may notify the user apparatus 150 carried by the notification target subject of the occurrence of the predetermined event, in addition to notifying the notification recipient terminal 170 of the positional information of the subject. The notification unit 114 corresponds to the notification means 14 illustrated in FIG. 1.

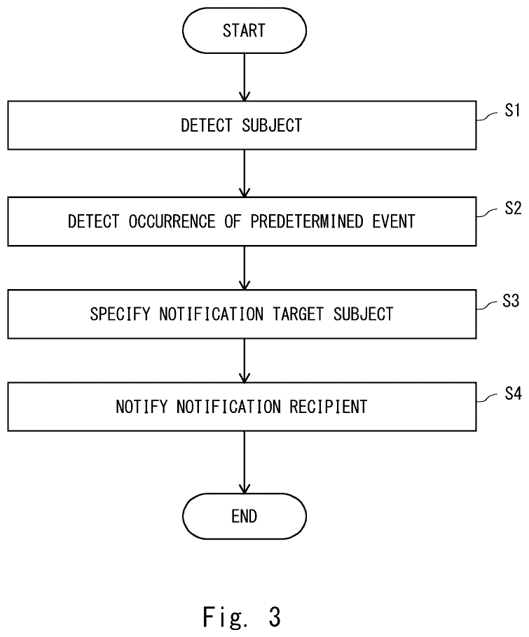

Next, an operation procedure will be described. FIG. 3 illustrates an operation procedure of the notification apparatus 110. The operation procedure of the notification apparatus 110 corresponds to a notification method. The subject detection unit 112 detects a watching target subject (step S1). In step S1, for example, in a case where predetermined information is received from the user apparatus 150 at an intersection where the camera 130 is installed, the subject detection unit 112 detects the subject at the intersection.

The event detection unit 111 detects occurrence of the predetermined event (step S2). In step S2, the event detection unit 111 detects the occurrence of the predetermined event based on, for example, a camera image acquired from the camera 130. The event detection unit 111 detects, for example, occurrence of an event in which a danger may occur to the subject. Any of steps S1 and S2 may be performed first or may be performed in parallel.

In a case where the occurrence of the predetermined event is detected in step S2, the specification unit 113 specifies the notification target subject (step S3). In step S3, for example, the specification unit 113 compares the positional information of the place where the occurrence of the predetermined event is detected with the positional information of the subject detected in step S1. For example, the specification unit 113 specifies a subject who is at the intersection that is the same as the intersection where the occurrence of the predetermined event is detected as a notification target subject.

The notification unit 114 notifies the notification recipient terminal 170 of the notification recipient related to the subject specified in step S3 of the positional information of the subject (step S4). In step S4, for example, the notification unit 114 may notify the notification recipient that the subject is near the place where the dangerous event occurs, in addition to the positional information of the subject. The notification recipient who is notified can rush to a site as necessary or can request a security company or the like to take action.

In the present example embodiment, the event detection unit 111 detects the occurrence of the predetermined event in a visual field range of the camera 130 based on the camera image. The subject detection unit 112 detects the positional information of a subject of the watching service based on information transmitted from the user apparatus 150. The specification unit 113 specifies the notification target subject based on the place where the occurrence of the predetermined event is detected and the positional information of the subject. In the present example embodiment, for example, in a case where occurrence of a dangerous event is detected, the specification unit 113 can specify a subject who is near the place as a notification target subject. The notification unit 114 notifies the notification recipient terminal 170 related to the notification target subject of the positional information of the subject. In the present example embodiment, even if the subject does not take any action, the notification recipient terminal 170 can be notified of the positional information of the subject. Therefore, in the present example embodiment, even if the subject is not aware of the occurrence of any event, the notification recipient can be notified that the subject is at a place related to the place where the predetermined event has occurred.

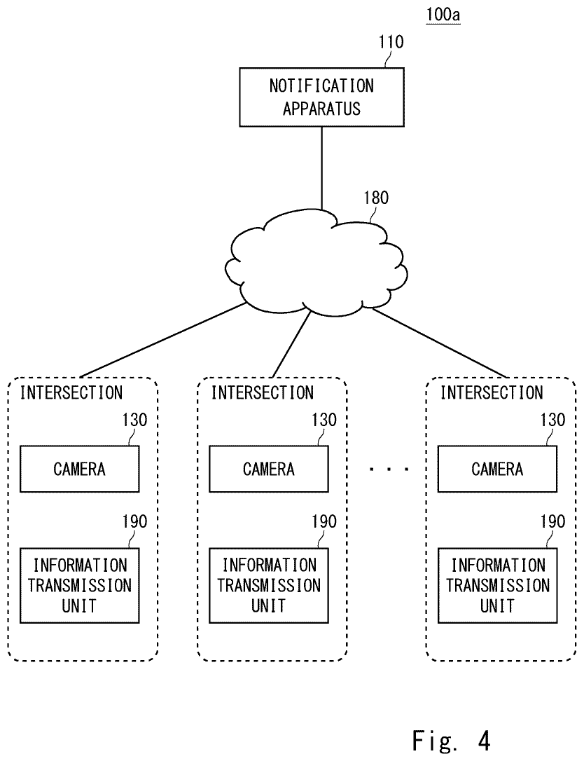

Next, a second example embodiment of the present disclosure will be described. FIG. 4 illustrates a notification system according to the second example embodiment of the present disclosure. In the present example embodiment, the notification apparatus 110 is connected to the plurality of cameras 130 and the plurality of information transmission units 190 via a network 180. The configuration of the notification apparatus 110 may be similar to the configuration of the notification apparatus 110 described in the first example embodiment illustrated in FIG. 2. The network 180 includes, for example, a wireless communication network using a communication line standard such as a 4-th generation mobile communication system or Long Term Evolution (LTE). The network 180 may include wireless communication networks such as WiFi (registered trademark), a 5th generation mobile communication system (5G), and local 5G.

In the present example embodiment, the plurality of cameras 130 and the plurality of information transmission units 190 are dispersedly disposed at a plurality of intersections. The number of cameras 130 disposed at each intersection is not necessarily limited to 1, and the plurality of cameras 130 may be disposed at each intersection. The number of information transmission units 190 disposed at each intersection is not necessarily limited to 1, and the plurality of information transmission units 190 may be disposed at each intersection. Further, a set of the camera 130 and the information transmission unit 190 is not necessarily disposed at each intersection, and one of the camera 130 and the information transmission unit 190 may be disposed at each intersection.

In the present example embodiment, the information transmission unit 190 receives predetermined information from the user apparatus 150 and transmits the received predetermined information to the notification apparatus 110 via the network 180. For example, in a case where the user apparatus 150 is a radio tag, the information transmission unit 190 receives identification information transmitted from the radio tag. The information transmission unit 190 transmits the received identification information to the notification apparatus 110 via the network 180.

The subject detection unit 112 (FIG. 2) of the notification apparatus 110 receives the predetermined information from the plurality of information transmission units 190 via the network 180. In a case where the predetermined information is received, the subject detection unit 112 detects the subject at the intersection where the information transmission unit 190 transmitting the predetermined information to the notification apparatus 110 is disposed. In this case, the subject detection unit 112 may detect, as the positional information of the subject, the positional information of the intersection where the information transmission unit 190 that is a transmission source of the information is disposed.

In the present example embodiment, each camera 130 transmits a camera image to the notification apparatus 110 via the network 180. The event detection unit 111 (see FIG. 2) of the notification apparatus 110 acquires camera images from the plurality of cameras 130 via the network 180. The event detection unit 111 determines whether a predetermined event has occurred at a plurality of places based on the camera images of the plurality of cameras 130.

In the present example embodiment, the specification unit 113 specifies the notification target subject based on the positional information of the place where the occurrence of the predetermined event is detected and the positional information of the subject detected by the subject detection unit 112. For example, in a case where the occurrence of the predetermined event is detected at a certain intersection, the specification unit 113 specifies a subject who is at the intersection as a notification target subject. In a case where the occurrence of the predetermined event is detected at the certain intersection, the specification unit 113 may specify a subject who is at the intersection and an intersection adjacent to the intersection as a notification target subject.

In the present example embodiment, the specification unit 113 may track the subject between the plurality of intersections based on a history of the positional information of the subject detected by the subject detection unit 112. The specification unit 113 may estimate the intersection where the subject moves based on a tracking result of the subject. In this case, the specification unit 113 may specify the subject estimated to move to the intersection where the occurrence of the predetermined event is detected as the notification target subject instead of or in addition to the subject who is at the intersection where the occurrence of the predetermined event is detected.

For example, it is assumed that a certain subject is detected at a certain intersection A, and then the same subject is detected at another intersection B. In this case, the specification unit 113 determines that the subject moves from the intersection A to the intersection B. It is assumed that the subject who has moved from the intersection A to the intersection B is highly likely to move to an intersection C subsequently from a geographical relationship between the intersections. In this case, the specification unit 113 estimates that the subject moves to the intersection C. In a case where the occurrence of the predetermined event is detected at the intersection C, the specification unit 113 can specify the subject estimated to move to the intersection C as the notification target subject in addition to the subject who is at the intersection C. In this case, if the subject is not currently at the intersection where the occurrence of the predetermined event is detected and it is estimated that the subject moves to the intersection where the occurrence of the predetermined event is detected subsequently, the notification unit 114 can notify the notification recipient terminal 170 of the positional information of the subject.

In the present example embodiment, the notification apparatus 110 can acquire camera images from the plurality of cameras 130. The notification apparatus 110 can acquire information transmitted from the user apparatus 150 from the plurality of information transmission units 190. The notification apparatus 110 can detect the occurrence of the predetermined event at a plurality of intersections and detect positional information of subjects at the plurality of intersections. In the present example embodiment, in a case where the occurrence of a predetermined event is detected at a certain intersection, the specification unit 113 can set not only the subject who is at the intersection but also the subject who is at an intersection different from the intersection where the occurrence of the predetermined event is detected as the notification target subject. Other effects are the same as those described in the first example embodiment.

In each of the above example embodiments, the notification apparatus 110 may not be required to be physically configured as one apparatus. In the first example embodiment, the notification apparatus 110 illustrated in FIG. 2 may be configured using a plurality of physically separated apparatuses. For example, the notification apparatus 110 may be configured using an apparatus installed at each intersection and an apparatus installed in a place such as a data center away from the intersection. Specifically, in the first example embodiment, the notification apparatus 110 may be separated into an apparatus including the event detection unit 111 and the subject detection unit 112 and an apparatus including the specification unit 113 and the notification unit 114. In this case, the notification apparatus 110 is also referred to as a notification system.

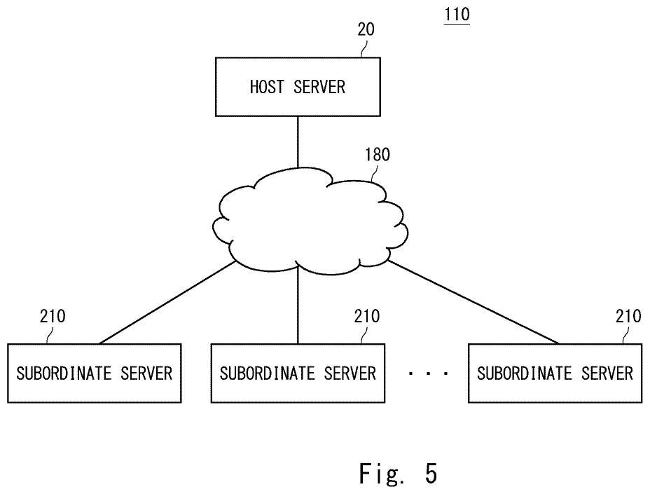

In the second example embodiment, the notification apparatus 110 may be configured using a plurality of hierarchical server devices. FIG. 5 illustrates a configuration example of a notification apparatus according to a modified example. In this example, the notification apparatus 110 that is a notification system includes a host server 200 and a plurality of subordinate servers 210. The host server 200 is, for example, a computer device such as a cloud server. The host server 200 is connected to the plurality of subordinate servers 210 via the network 180. The subordinate server 210 may be configured as a computer device such as a multi-access/mobile edge computing (MEC) server. The subordinate server 210 can be disposed, for example, at each intersection where the camera 130 (see FIG. 4) is arranged.

In the notification apparatus 110 illustrated in FIG. 5, the host server 200 may include the specification unit 113 and the notification unit 114 illustrated in FIG. 2. Each subordinate server 210 may include an event detection unit 111 and a subject detection unit 112 illustrated in FIG. 2. In this case, each subordinate server 210 detects positional information of the subject, for example, at an intersection. Each subordinate server 210 detects occurrence of a predetermined event at the intersection. The subordinate server 210 transmits the positional information of the detected subject and the occurrence of the detected predetermined event to the host server 200. The host server 200 specifies a notification subject using the information received from the subordinate server 210 and notifies the specified notification subject of the positional information of the subject.

In the notification apparatus 110 illustrated in FIG. 5, at least some of the plurality of subordinate servers 210 may include the specification unit 113 and the notification unit 114 in addition to the event detection unit 111 and the subject detection unit 112. In this case, if the occurrence of the predetermined event is detected at the intersection where the subordinate server 210 is disposed, the specification unit 113 of the subordinate server 210 may specify the subject who is at the intersection as a notification target subject. The notification unit 114 of the subordinate server 210 notifies, of the positional information of the subject, a notification recipient specified as the notification target subject and related to the subject who is at the intersection where the subordinate server 210 is disposed.

On the other hand, the specification unit 113 of the host server 200 may specify a subject who is at an intersection different from the intersection where the occurrence of the predetermined event is detected as the notification target subject. In this case, the notification unit 114 of the host server 200 notifies, of the positional information of the subject, the notification recipient specified as the notification target subject and related to the subject who is at the intersection different from the intersection where the occurrence of the predetermined event is detected. In a case where the above-described operation is performed, each subordinate server 210 can specify the notification target subject and notify the notification recipient of the positional information at the intersection where the subordinate server 210 is disposed. The host server 200 can specify the notification subject and notify the notification recipient of the positional information across a plurality of intersections.

In each of the above example embodiments, the example in which the event detection unit 111 detects the occurrence of the predetermined event based on the camera image of the camera 130 has been described. However, the present disclosure is not limited thereto. The event detection unit 111 may detect occurrence of the predetermined event by using information acquired from a vehicle using road-to-vehicle communication via, for example, a road side unit (RSU). Alternatively, the event detection unit 111 may detect the occurrence of the predetermined event by using information acquired from an external server that manages traffic accident information or the like via a network such as the Internet.

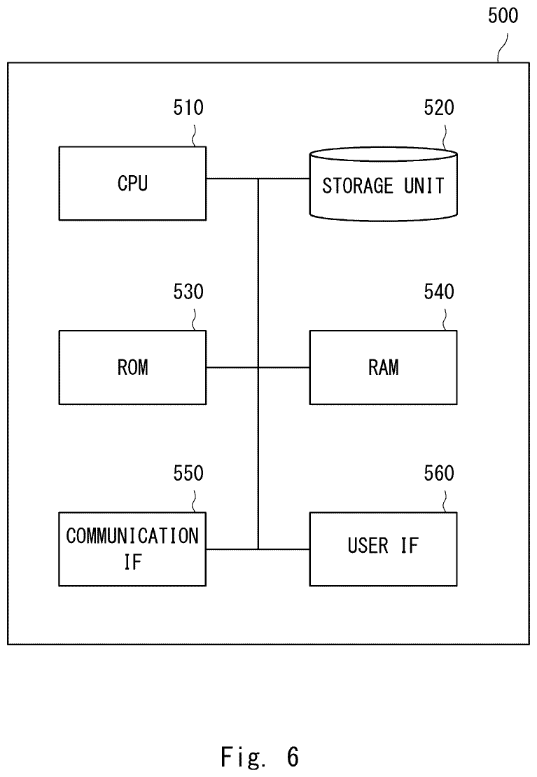

Next, a hardware configuration of the notification apparatus 110 will be described. FIG. 6 illustrates a configuration example of a computer device that can be used in the notification apparatus 110. A computer device 500 includes a control unit (CPU) 510, a storage unit 520, a read only memory (ROM) 530, a random access memory (RAM) 540, a communication interface (IF) 550, and a user interface 560.

The communication interface 550 is an interface connecting the computer device 500 to a communication network through wired communication means, wireless communication means, or the like. The user interface 560 includes, for example, a display unit such as a display. The user interface 560 also includes input units such as a keyboard, a mouse, and a touch panel.

The storage unit 520 is an auxiliary storage device that can hold various types of data. The storage unit 520 does not need to be a part of the computer device 500 and may be an external storage device or a cloud storage connected to the computer device 500 via a network.

The ROM 530 is a nonvolatile storage device. For example, a semiconductor storage device such as a flash memory that has a relatively small capacity may be used for the ROM 530. A program that is executed by the CPU 510 may be stored in the storage unit 520 or the ROM 530. The storage unit 520 or the ROM 530 stores, for example, various programs realizing the functions of units of the notification apparatus 110.

The above program includes an instruction group or software codes causing a computer to perform one or more functions described in the example embodiments when the program is read by the computer. The program may be stored in a non-transitory computer-readable medium or a tangible storage medium. As an example and not by way of limitation, the computer-readable medium or the tangible storage medium includes a RAM, a ROM, a flash memory, a solid-state drive (SSD) or any other memory technology, a compact disc (CD), a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, the transitory computer-readable medium or the communication medium includes an electrical signal, an optical signal, an acoustic signal, or any other form of propagation signal.

The RAM 540 is a volatile storage device. As the RAM 540, various types of semiconductor memory devices such as a dynamic random access memory (DRAM) or a static random access memory (SRAM) may be used. The RAM 540 may be used as an internal buffer that temporarily stores data or the like. The CPU 510 loads a program stored in the storage unit 520 or the ROM 530, in the RAM 540 and executes the loaded program. Functions of the units in the notification apparatus 110 can be implemented by the CPU 510 executing the program. The CPU 510 may include an internal buffer in which data or the like can be temporarily stored.

Although the example embodiments of the present disclosure have been described above in detail, the present disclosure is not limited to the above-described example embodiments, and the present disclosure also includes changes or modifications made to the above-described example embodiments without departing from the gist of the present disclosure. For example, the matters described in the above example embodiments can be appropriately combined.

For example, some or all of the above-described example embodiments may be described as the following Supplementary Notes, but the present disclosure is not limited to the following Supplementary Notes.

### Supplementary Note 1

A notification apparatus including:
event detection means for detecting that a predetermined event has occurred;
positional information detection means for detecting positional information of a subject who is a position detection target person;
specification means for specifying a notification target subject based on positional information of a place where occurrence of the predetermined event is detected and the detected positional information; and
notification means for notifying a terminal of a notification recipient registered in association with the subject specified by the specification means of positional information of the subject.

### Supplementary Note 2

The notification apparatus according to Supplementary Note 1, wherein the event detection means detects occurrence of the predetermined event based on a camera image captured using a camera.

### Supplementary Note 3

The notification apparatus according to Supplementary Note 1 or 2, wherein the specification means specifies a subject who is in a place related to a place where the predetermined event has occurred as the notification target subject based on positional information of the place where the occurrence of the predetermined event is detected and the detected positional information.

### Supplementary Note 4

The notification apparatus according to any one of Supplementary Notes 1 to 3, wherein the specification means specifies a subject who is within a predetermined distance from a place where occurrence of the predetermined event is detected as the notification target subject.

### Supplementary Note 5

The notification apparatus according to any one of Supplementary Notes 1 to 4, wherein
the event detection means detects occurrence of a predetermined event at an intersection, and
the specification means specifies a subject who is at an intersection that is identical to an intersection where the occurrence of the predetermined event is detected as the notification target subject.

### Supplementary Note 6

The notification apparatus according to any one of Supplementary Notes 1 to 5, wherein the positional information detection means receives identification information from a radio tag carried by the subject and detects positional information of the subject.

### Supplementary Note 7

The notification apparatus according to any one of Supplementary Notes 1 to 6, wherein the specification means estimates a movement destination of the subject based on a history of positional information of the detected subject and specifies a subject estimated to move to a place where occurrence of the predetermined event is detected as the notification target subject.

### Supplementary Note 8

The notification apparatus according to any one of Supplementary Notes 1 to 7, wherein the event detection means determines whether the predetermined event has occurred at a plurality of places.

### Supplementary Note 9

A notification system including:
event detection means for detecting that a predetermined event has occurred;
positional information detection means for detecting positional information of a subject who is a position detection target person;
specification means for specifying a notification target subject based on positional information of a place where occurrence of the predetermined event is detected and the detected positional information; and
notification means for notifying a terminal of a notification recipient registered in association with the subject specified by the specification means of positional information of the subject.

### Supplementary Note 10

The notification system according to Supplementary Note 9, further including one or more cameras,
wherein the event detection means detects occurrence of the predetermined event based on a camera image captured using the camera.

### Supplementary Note 11

The notification system according to Supplementary Note 10, wherein
the one or more cameras are disposed at one or more intersections,
the event detection means detects occurrence of a predetermined event at the intersection, and
the specification means specifies a subject who is at an intersection that is identical to the intersection where the occurrence of the predetermined event is detected as the notification target subject.

### Supplementary Note 12

The notification system according to any one of Supplementary Notes 9 to 11, further including a user apparatus carried by the subject,
wherein the positional information detection means receives information transmitted from the user apparatus and detects positional information of the subject.

### Supplementary Note 13

The notification system according to Supplementary Note 12, wherein the user apparatus is a radio tag that transmits identification information.

### Supplementary Note 14

A notification method including:
detecting that a predetermined event has occurred;
detecting positional information of a subject who is a position detection target person;
specifying a notification target subject based on positional information of a place where occurrence of the predetermined event is detected and the detected positional information; and
notifying a terminal of a notification recipient registered in association with the specified subject of positional information of the subject.

### Supplementary Note 15

A non-transitory computer-readable medium storing a program that causes a processor to execute processes including:
detecting that a predetermined event has occurred;
detecting positional information of a subject who is a position detection target person;
specifying a notification target subject based on positional information of a place where occurrence of the predetermined event is detected and the detected positional information; and
notifying a terminal of a notification recipient registered in association with the specified subject of positional information of the subject.

### REFERENCE SIGNS LIST

10 NOTIFICATION APPARATUS
11 EVENT DETECTION MEANS
12 POSITIONAL INFORMATION DETECTION MEANS
13 SPECIFICATION MEANS
14 NOTIFICATION MEANS
100 NOTIFICATION SYSTEM
110 NOTIFICATION APPARATUS
111 EVENT DETECTION UNIT
112 SUBJECT DETECTION UNIT
113 SPECIFICATION UNIT
114 NOTIFICATION UNIT
130 CAMERA
150 USER APPARATUS
170 NOTIFICATION RECIPIENT TERMINAL
180 NETWORK
190 INFORMATION TRANSMISSION UNIT
200 HOST SERVER
210 SUBORDINATE SERVER
500 COMPUTER DEVICE
510 CPU
520 STORAGE UNIT
530 ROM
540 RAM
550 COMMUNICATION INTERFACE
560 USER INTERFACE

What is claimed is:

1. A notification apparatus comprising:
at least one memory storing instructions; and
at least one processor configured to execute the instructions to:
detect that a predetermined event has occurred;
detect positional information of a subject who is a position detection target person;
specify a notification target subject based on positional information of a place where occurrence of the predetermined event is detected and the detected positional information; and
notify a terminal of a notification recipient registered in association with the specified subject of positional information of the subject.

2. The notification apparatus according to claim 1, wherein the at least one processor is configured to execute the instructions to detect occurrence of the predetermined event based on a camera image captured using a camera.

3. The notification apparatus according to claim 1, wherein the at least one processor is configured to execute the instructions to specify a subject who is in a place related to a place where the predetermined event has occurred as the notification target subject based on positional information of the place where the occurrence of the predetermined event is detected and the detected positional information.

4. The notification apparatus according to claim 1, wherein the at least one processor is configured to execute the instructions to specify a subject who is within a predetermined distance from a place where occurrence of the predetermined event is detected as the notification target subject.

5. The notification apparatus according to claim 1, wherein the at least one processor is configured to execute the instructions to:
detect occurrence of a predetermined event at an intersection, and
specify a subject who is at an intersection that is identical to an intersection where the occurrence of the predetermined event is detected as the notification target subject.

6. The notification apparatus according to claim 1, wherein the at least one processor is configured to execute the instructions to receive identification information from a radio tag carried by the subject and detects positional information of the subject.

7. The notification apparatus according to claim 1, wherein the at least one processor is configured to execute the instructions to estimate a movement destination of the subject based on a history of positional information of the detected subject and specifies a subject estimated to move to a place where occurrence of the predetermined event is detected as the notification target subject.

8. The notification apparatus according to claim 1, wherein the at least one processor is configured to execute the instructions to determine whether the predetermined event has occurred at a plurality of places.

9.-13 (canceled)

14. A notification method comprising:
detecting that a predetermined event has occurred;
detecting positional information of a subject who is a position detection target person;
specifying a notification target subject based on positional information of a place where occurrence of the predetermined event is detected and the detected positional information; and
notifying a terminal of a notification recipient registered in association with the specified subject of positional information of the subject.

15. A non-transitory computer-readable medium storing a program that causes a processor to execute processes comprising:
detecting that a predetermined event has occurred;
detecting positional information of a subject who is a position detection target person;
specifying a notification target subject based on positional information of a place where occurrence of the predetermined event is detected and the detected positional information; and
notifying a terminal of a notification recipient registered in association with the specified subject of positional information of the subject.
